(19) United States
(12) Patent Application Publication
(10) Pub. No.: US 2014/0100493 A1
(43) Pub. Date: Apr. 10, 2014

(54) Bipedal Exoskeleton and Methods of Use

(71) Applicants: Travis Craig, Pensacola, FL (US); Roger Kovekamp, Pensacola, FL (US); Peter Neuhaus, Pensacola, FL (US); Jerryll Noorden, Pensacola, FL (US); Nic Payton, Pensacola, FL (US); Nic Radford, Houston, TX (US)

(72) Inventors: Travis Craig, Pensacola, FL (US); Roger Kovekamp, Pensacola, FL (US); Peter Neuhaus, Pensacola, FL (US); Jerryll Noorden, Pensacola, FL (US); Nic Payton, Pensacola, FL (US); Nic Radford, Houston, TX (US)

(21) Appl. No.: 14/046,094

(22) Filed: Oct. 4, 2013

Related U.S. Application Data
(60) Provisional application No. 61/709,489, filed on Oct. 4, 2012.

(51) Int. Cl. A61H 3/00; B25J 9/00

(52) U.S. Cl. CPC A61H 3/00; B25J 9/0006
USPC 601/35

(57) ABSTRACT

A bipedal exoskeleton configured to be worn by a human user. The exoskeleton includes a soft “backpack”-style harness that interfaces primarily with the user's waist, back, and shoulders. A chassis is provided to mount two positively-driven legs. Each leg includes features that are analogous to a human leg—a hip joint, a thigh, a knee joint, a calf, and a foot plate. Each leg of the exoskeleton is physically connected to one of the human user's legs. A thigh cuff is used to connect to the user's thigh. A shin cuff is used to connect to the user's calf. A foot plate rests beneath the sole of the user's foot. Power actuators are provided in the exoskeleton's hip and knee joints, and possibly additional locations. A user interface is provided in one or more locations so that the user can control desired functions of the exoskeleton.

### CROSS-REFERENCES TO RELATED APPLICATIONS

This non-provisional patent application claims the benefit of an earlier-filed provisional patent application. The provisional application was assigned Ser. No. 61/709,489. It was filed on Oct. 4, 2012.

### STATEMENT REGARDING FEDERALLY SPONSORED RESEARCH OR DEVELOPMENT

This invention was funded at least in part under a National Aeronautics and Space Administration contract and is subject to 35 U.S.C. section 200 et. seq. At least a portion of the invention was also made in the performance of work under a NASA contract and is subject to the provisions of Section 305 of the National Aeronautics and Space Act of 1958, Public Law 85-568 (now 51 U.S.C. §20135). At least one of the named inventors was employee of the United States Government at the time the invention was made and the United States thereby obtained certain rights of use of the invention without the payment of any royalties.

### MICROFICHE APPENDIX

Not Applicable member

### BACKGROUND OF THE INVENTION

1. Field of the Invention

This invention relates to the field of robotics. More specifically, the invention comprises a bipedal exoskeleton configured to be worn and used by a human operator.

2. Description of the Related Art

An exoskeleton is a device that is worn by a user and employed to supplement or substitute for the normal motive forces provided by the human body. A bipedal exoskeleton is primarily worn on a human operator's legs. However, most such devices also have some means to transmit loads to the wearer's hips and trunk.

Some bipedal exoskeletons have been conceived as aids to human motive power. That is, they provide additional strength and/or endurance for a user having no prior impairment. Other bipedal exoskeletons have been developed to aid an impaired operator, where some or all of the normal leg functions have been lost.

Exoskeletons have various types have also been developed to assist exercise and strength maintenance in the extended microgravity environment. For some time now scientists have recognized that muscle mass and even bone density is lost when the human body remains in a microgravity environment for an extended period. Exoskeletons may be used to impose mechanical forces on the body that the wearer must resist. For example, an exoskeleton may be used to mimic gravitational forces when a wearer is performing leg exercises. An exoskeleton may even be used to impose minor forces that the user is required to counteract while performing other tasks.

The reader will thereby perceive that a need presently exists for a practical bipedal exoskeleton. The present invention provides such a device.

### BRIEF SUMMARY OF THE PRESENT INVENTION

The present invention comprises a bipedal exoskeleton configured to be worn by a human user. The exoskeleton includes a soft “backpack”-style harness that interfaces primarily with the user's waist, back, and shoulders. A chassis is provided to mount two positively-driven legs. Each leg includes features that are analogous to a human leg—a hip joint, a thigh, a knee joint, a calf, and a foot plate. Each leg of the exoskeleton is physically connected to one of the human user's legs. A thigh cuff is used to connect to the user's thigh. A shin cuff is used to connect to the user's calf. A foot plate rests beneath the sole of the user's foot.

Power actuators are provided in the exoskeleton's hip and knee joints, and possibly additional locations. A user interface is provided in one or more locations so that the user can control desired functions of the exoskeleton. A housing located near the user's lumbar spine preferably contains a power source, such as electrical storage batteries. The housing also preferably contains a central processing unit that runs software controlling the exoskeleton's functions.

### BRIEF DESCRIPTION OF THE SEVERAL VIEWS OF THE DRAWINGS

FIG. 1 is a front elevation view, showing the bipedal exoskeleton in a walking stance.

FIG. 2 is a left from perspective view, showing the bipedal exoskeleton in the same stance as FIG. 1.

FIG. 3 is a left side elevation view, showing the bipedal exoskeleton in the same stance as FIG. 1.

FIG. 4 is a left rear perspective view, showing the bipedal exoskeleton in the same stance as FIG. 1.

FIG. 5 is a rear elevation view, showing the bipedal exoskeleton in the same stance as FIG. 1.

FIG. 6 is a right side elevation view, showing the bipedal exoskeleton in the same stance as FIG. 1.

FIG. 7 is a right rear perspective view, showing the bipedal exoskeleton in the same stance as FIG. 1.

FIG. 8 is a right front perspective view, showing the bipedal exoskeleton in the same stance as FIG. 1.

FIG. 9 is a front elevation view, showing the bipedal exoskeleton being worn by a human user.

FIG. 10 is a rear perspective view, showing the bipedal exoskeleton being worn by a human user.

FIG. 11 is a detailed perspective view, showing a user interface located on a waist belt.

REFERENCE NUMERALS IN THE DRAWINGS

| | | | |
|---|---|---|---|
| 10 | exoskeleton | 12 | housing |
| 14 | column | 16 | backpack frame |
| 18 | lumbar pad | 20 | internal/external rotation joint |
| 22 | hip actuator | 24 | thigh |
| 26 | knee actuator | 28 | calf |
| 30 | foot plate | 32 | thigh cuff |
| 34 | shin cuff | 36 | length adjustment |
| 38 | chassis | 40 | ankle assembly |
| 42 | posterior interface panel | 44 | abduction/adduction joint |
| 46 | ankle joint | 48 | extension member |
| 50 | posterior interface panel | 52 | operator |
| 54 | shoulder strap | 56 | belt |
| 58 | anterior interface panel | | |

### DETAILED DESCRIPTION OF THE INVENTION

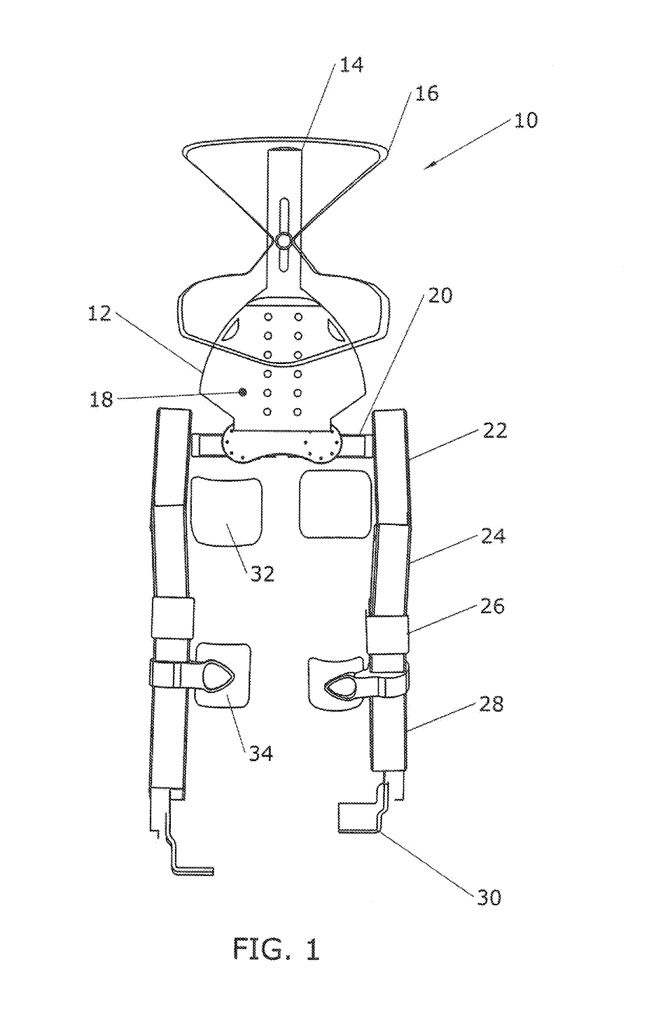

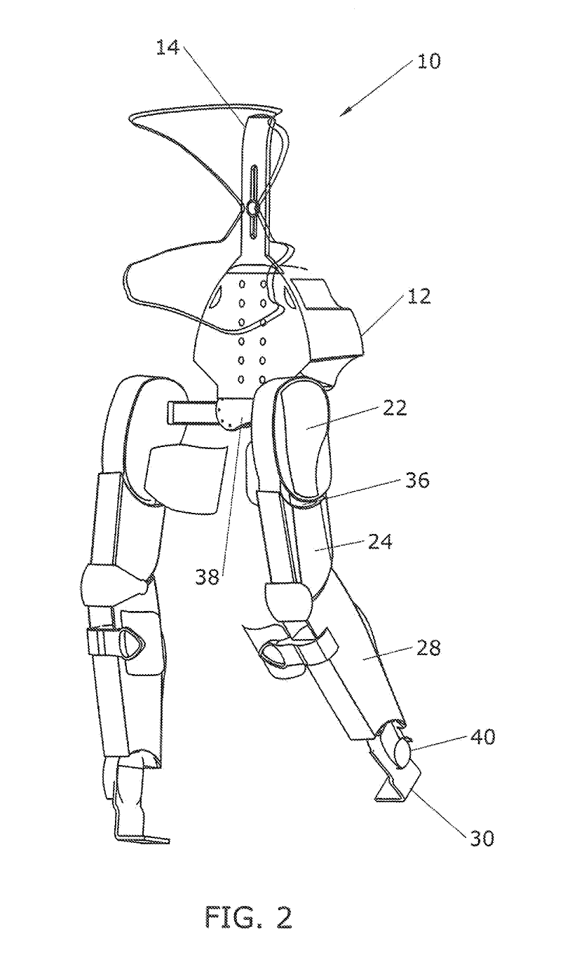

FIG. 1 shows a front elevation view of exoskeleton 10 made according to the present invention. FIG. 2 shows a right front perspective view of the exoskeleton in the same configuration. The exoskeleton is designed to be worn by a human user. Its two legs operate in parallel with the normal range of motion of the user's legs. The exoskeleton legs lie on the lateral outward side of each leg of the operator.

The two legs are attached to chassis 38. Housing 12 is also connected to chassis 38. The housing preferably contains one or more central processing units (“CPU”) running software that controls the functions of the exoskeleton. Sensors are provided so that the control can be closed-loop. For instance, sensors may be provided to determine the position of each joint in the exoskeleton and the force applied to the joint. The CPU uses this formation to control the motion of the joints.

Returning not to FIG. 1, the basic components of a preferred embodiment of the exoskeleton will be explained. The front part of housing 12 includes lumbar pad 18. This region abuts the user's lumbar spine. It may be provided with soft material to enhance comfort. Column 14 extends upward from housing 12. Backpack frame 16 is connected to column 14. The connection is preferably made movable so that the height of the backpack frame may be adjusted.

Backpack frame 16 is shown as an assembly of rigid tubing. The backpack frame includes other “soft” components—such as shoulder straps, and a belt. Such components are well understood by those skilled in the art. They have not been illustrated in FIG. 1 in order to aid visual clarity.

The chassis mounting the two legs is just below housing 12. Each leg assembly is connected to the chassis. These connections preferably allow adjustment in order to conform to a particular user's anatomy. As an example, internal/external rotation joint 20 may be provided to adjust to a particular user's hip joint angle. Adjustments are preferably also provided for abduction/adduction and the width between the user's hip joints.

Hip actuator 22 rotationally activates the exoskeleton's hip joint in order to move thigh 24 and everything below the thigh. Reactive forces caused by the movement of the hip joint are counteracted by the lumbar pad and backpack assembly being attached to the user's torso.

Knee actuator 26 rotationally activated the exoskeleton's knee joint to move calf 28 and everything attached to the calf. Footplate 30 is connected to the lower portion of the calf. It slides under the user's foot and may in fact rest within the interior a shoe being worn by the user. The foot plate may be connected using an ankle joint. The ankle joint may include some passive flexible features. It could also include additional powered joints. Carbon fiber insoles may be attached to the footplate. These slip inside the user's shoes in the same position as a conventional insole. However, their strength and stiffness allow high loads to be transferred directly from the sole of the shoe to the exoskeleton.

Thigh cuff 32 is passed around the user's thigh. It secures the user's thigh to thigh 24. Likewise, shin cuff 34 passes around the user's calf and secures the user's calf to calf 28 of the exoskeleton. Length adjustments are provided in the exoskeleton's legs to account for variations in user anatomy. Turning again to FIG. 2 the reader will observe that the length of thigh 24 may be adjusted by expanding or contracting length adjustment 36. This adjustment places the rotational thigh and hip joints of the exoskeleton in line with the user's hip and knee joints.

The distance between the exoskeleton's knee and foot plate 30 is adjusted by adjusting how far foot plate 30 extends out of the bottom of calf 28. Ankle assembly 40 may also include additional degrees of freedom which may also be made adjustable.

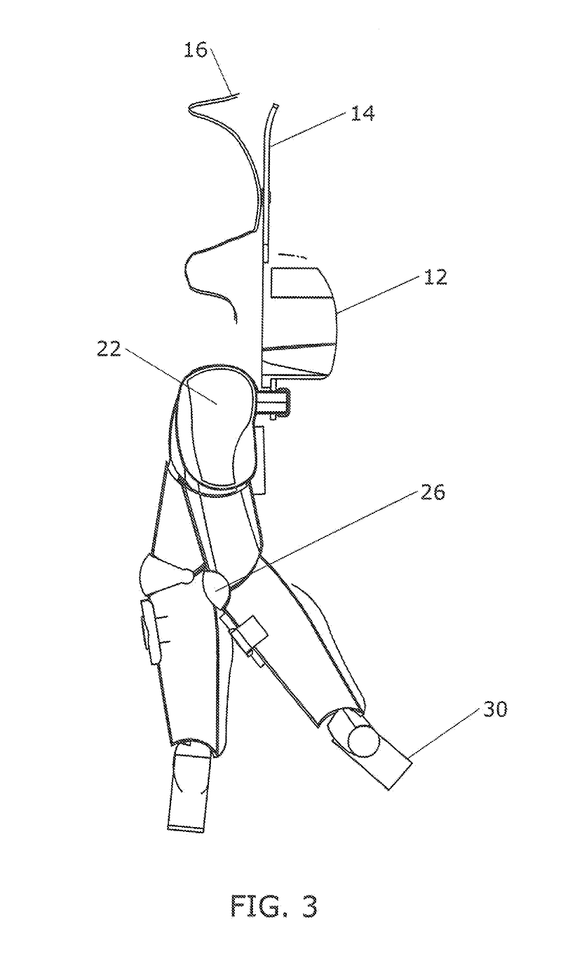

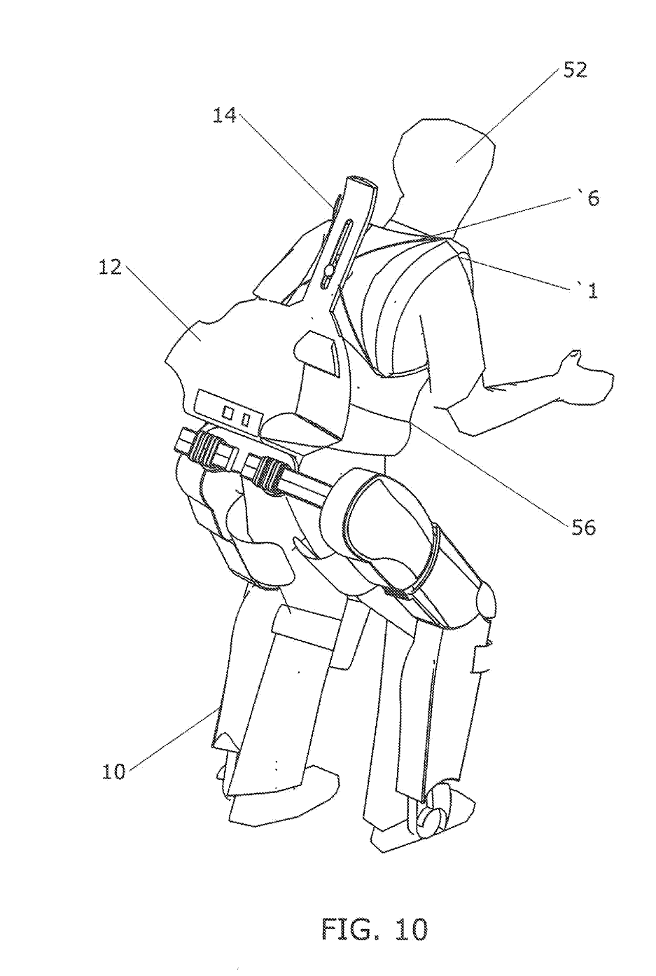

Turning briefly to FIG. 10, the reader may generally observe how the exoskeleton 10 is worn by an operator 52. Looking again at FIG. 3, the reader will observe that the necessity of accommodating the operator's anatomy means that housing 12 and column 14 must be moved rearward from the axis running through the two hip actuators 22. Hip actuators 22 are preferably in line with the approximate axis of flexion/extension for the operator's hips. Likewise, each knee actuator 26 is preferably in line with the axis of flexion/extension for the operator's knee.

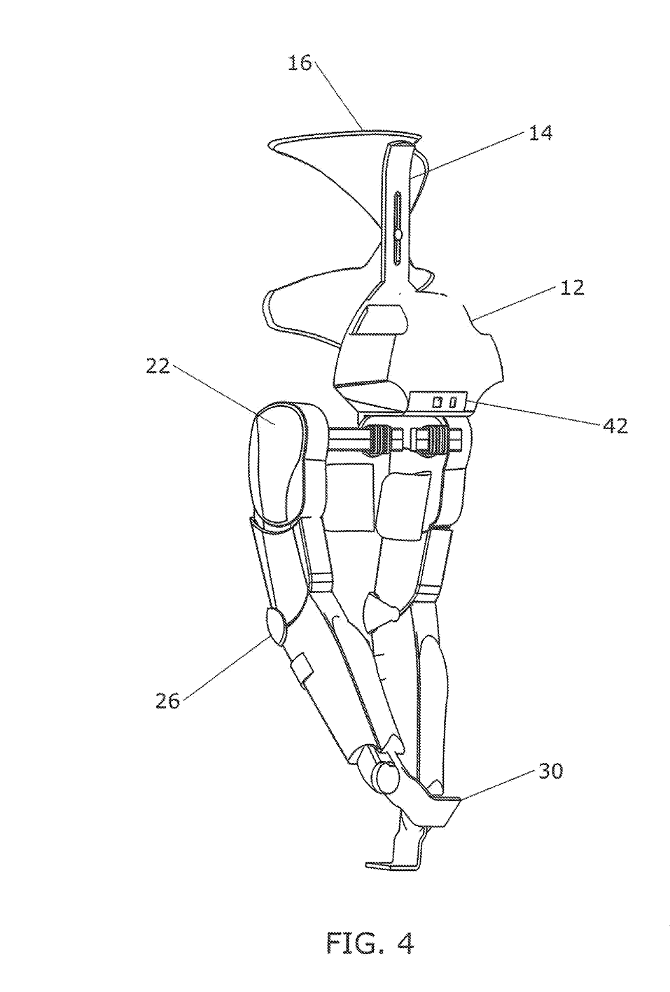

FIG. 3 shows the exoskeleton in a forward walking configuration. The foot plate of the right leg is on the ground and beginning the thrust portion of the walking gait. Foot plate 30 of the left leg has lifted clear of the ground and is just starting its forward swing. FIG. 4 shows the identical portion of the gait sequence from the left rear. Torque is applied to hip actuator 22 to rotate the thigh forward. In this portion of the gait torque is applied to knee actuator 26 in a direction that will actually rotate the calf in the opposite direction as the thigh (tucking the calf upward for the forward “swing” phase of the walking gait).

One or more user interfaces are provided for controlling the exoskeleton. Posterior interface 42 is located on a portion of housing 12. It allows a person not wearing exoskeleton to interact with the CPU. Posterior interface 42 may also be used by the operator once he or she has removed the exoskeleton. The operator may also be able to reach back and actuate elements within posterior interface 42 while wearing the exoskeleton. A radio frequency transceiver may also be provided to allow wireless external communications.

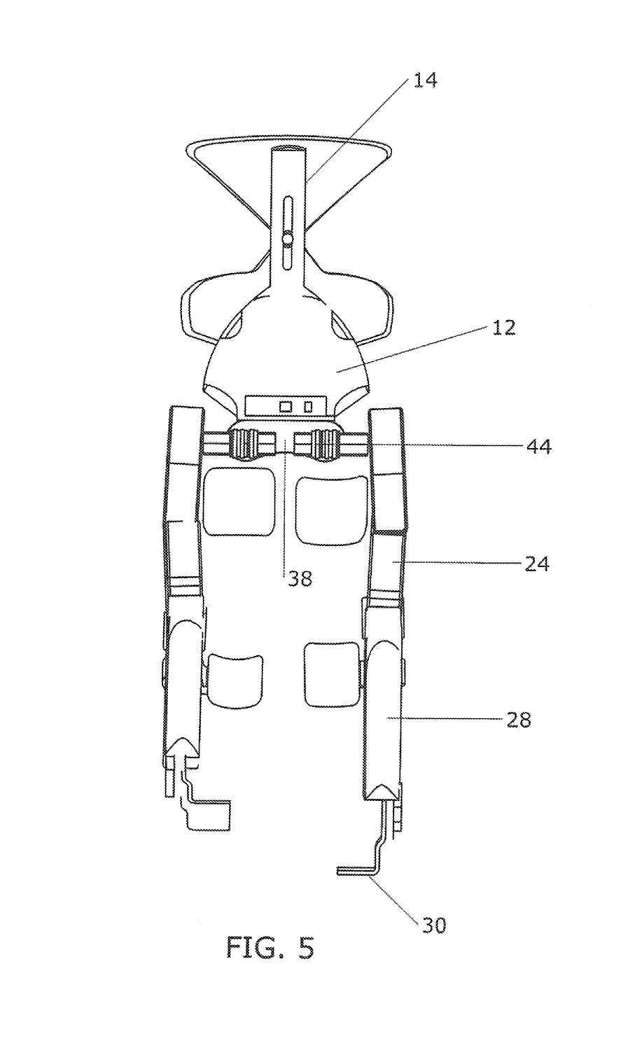

FIG. 5 shows exoskeleton from the rear (in the sane phase of the walking gait). Abduction/adduction joint 44 is preferably provided so that the exoskeleton legs may be pivoted to match the use's neutral abduction/adduction point. Lateral adjustment mechanisms are preferably also provided to alter the overall width of the exoskeleton legs.

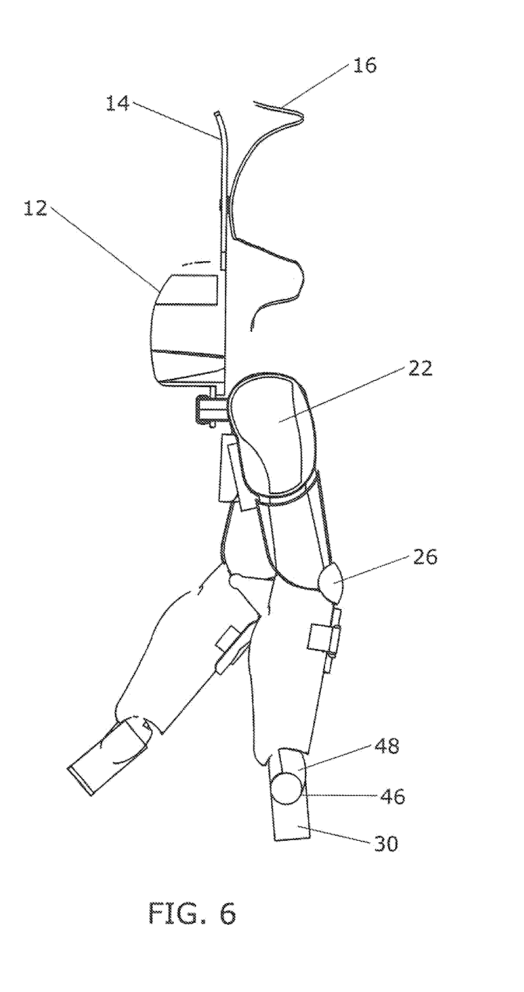

FIG. 6 shows a tight side elevation view in the same phase of the walking gait. Torque is applied to hip actuator 22 of the right leg to rotate the right thigh rearward. Torque is also applied to knee actuator 26 to hold the knee joint in fairly constant position and then push off near the end of the stride.

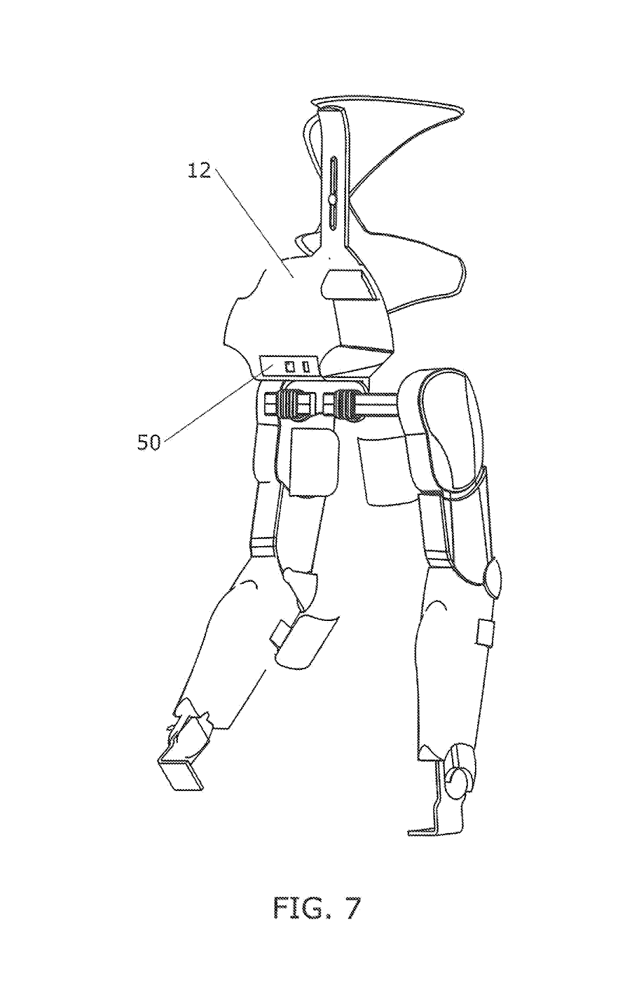

FIG. 7 shows a right rear perspective view of the same phase of the gait. Although the exoskeleton's legs appear to be set very far apart, the reader should recall that the legs are designed to be located just outside the operator's own stance. Thus, the exoskeleton must provide room for the operator's body.

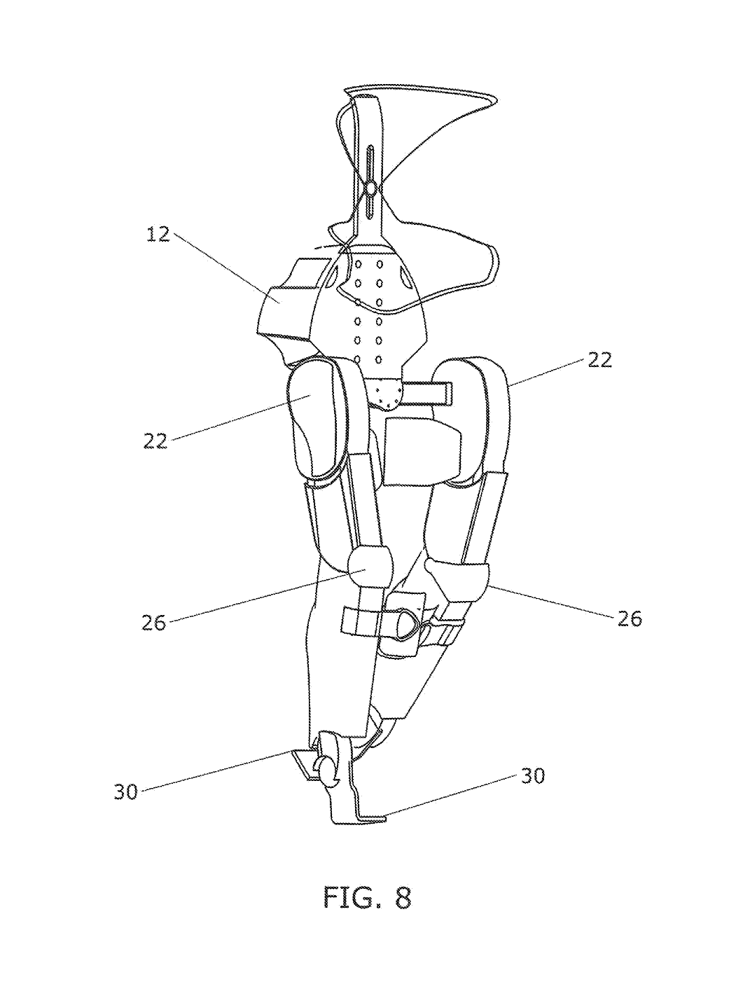

FIG. 8 shows a right front perspective view of the exoskeleton. Hip actuators 22 and knee actuators 26 are individually controlled for the two legs so that the two legs may move independently yet act cooperatively in producing a desired motion.

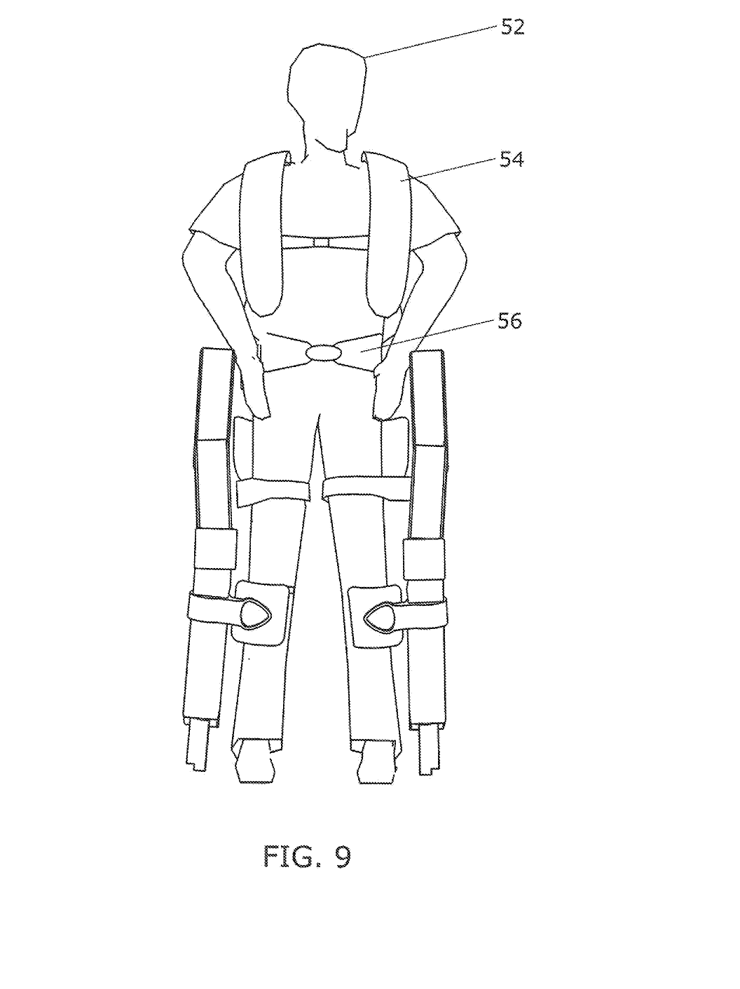

FIG. 9 shows exoskeleton 10 being worn by an operator 52. Thigh cuffs 32 have been secured around the operator's thighs and shin cuffs 34 have been secured around the calves. The view shows several soft webbing components that have been added to the backpack frame. Belt 56 is secured around the operator's waist. The belt is secured to housing 12 and/or the balance of the backpack frame. Shoulder straps 54 are secured to the backpack frame. Conventional buckles and snaps are provided so that the user may easily don the webbing and secure it in position. Adjustment features are also provided so that the user can adjust the tightness of the various webbing components.

FIG. 10 shows a rear perspective view of operator 52 wearing exoskeleton 10. The reader will observe how the rigid (or semi-rigid) backpack frame 16 operates in concert with the softer webbing components such as shoulder straps 54. The webbing (shoulder straps, belt, etc.), backpack frame, column, housing, and chassis secure the upper portion of the exoskeleton to the operator. These components are collectively referred to as a “backpack harness.” This securing is desirable since applying torque to the hip or knee actuators of the exoskeleton will of course produce reactive forces that must be resisted.

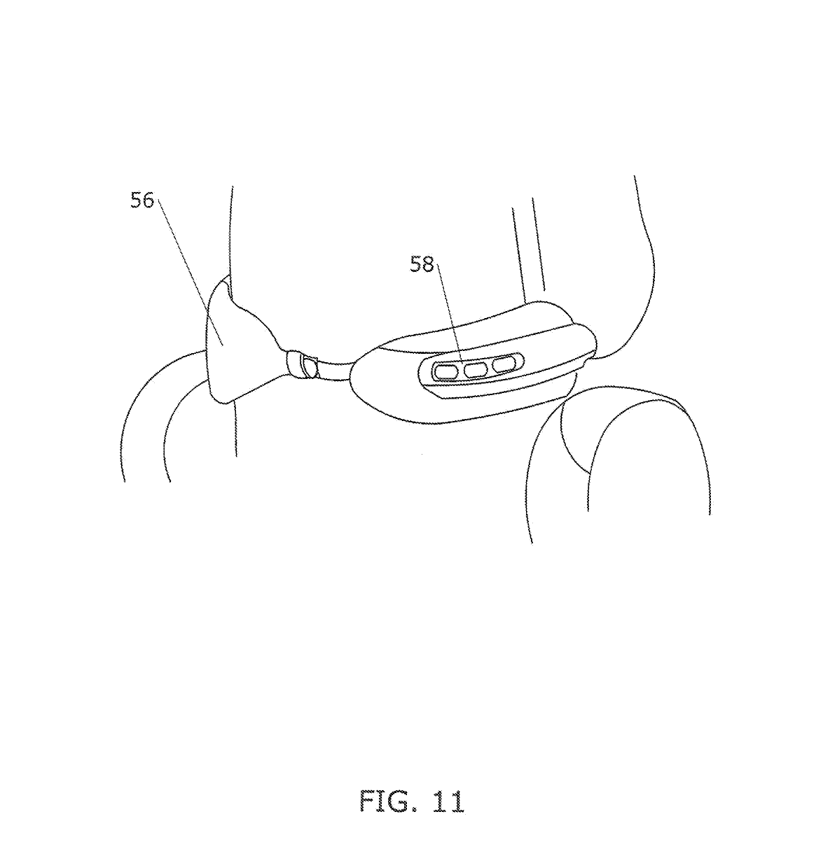

FIG. 11 provides a detailed perspective view of the front portion of belt 56. In this embodiment, anterior interface 58 is provided on the belt. The anterior interface contains suitable controls allowing the user to control desirable functions of the exoskeleton. The sensors provided for control of the exoskeleton preferably include one or more of the following:

(1) joint position sensors;

(2) joint torque sensors;

(3) joint velocity and acceleration sensors;

(4) inertial measurement sensors; and

(5) force sensors—such as in the contact area of the foot plate.

The sensors provided, in conjunction with the operation of the CPU, are preferably able to determine position, velocity, and acceleration of each joint. The CPU is preferably able to determine the position, velocity, and acceleration of the exoskeleton as a whole.

Each actuator preferably includes a low-level local control system. The low-level control system is preferably able to receive a feedback signal from a localized sensor (such as a torque sensor) and adjust the electrical power applied to the actuator to produce the desired result.

In a first mode of operation the exoskeleton automatically operates the legs to produce a desired result—such as a walking gait—without any action of the human operator being “in the loop.” In a second mode of operation the exoskeleton receives force inputs from the operator and seeks to discern the operator's intent before carrying out that intent. For instance, for an operator with compromised leg strength the exoskeleton may act as a force multiplier. In this mode the exoskeleton would sense the operator's extension of her left thigh and provide torque to the left hip actuator to assist the user is making that motion.

The exoskeleton could also provide stability augmentation for person's with compromised balance. Force sensors in the footplate, along with the possible use of an inertial measurement unit, could be used to determine balance states. The actuators could then be controlled to maintain balance.

In still another mode of operation the bipedal exoskeleton could be used to counteract the degeneration of the human body in the microgravity environment. The exoskeleton could carry out the steps of: (a) measuring a force of bipedal motion applied by the human operator using sensors within the exoskeleton; (b) encoding the measured force of bipedal motion as a set of feedback signals; (c) calculating a resistive exercise force as a function of the measured force; and (d) energizing the actuators to provide a resistive exercise device for the human operator.

A preferred embodiment of the exoskeleton has ten degrees of freedom or “joints.” Powered joints are provided at the hips and knees. Six additional joints are preferably unpowered but mobile. These allow the human operator a degree of freedom in these additional directions for sidestepping, turning, pointing of the foot, and flexing of the foot. The three additional (unpowered) degrees of freedom allowed for each leg preferably include:

(1) Internal/external rotation;

(2) Abduction/adduction; and

(3) Planar and dorsal flexion

In additional embodiments, some of the six additional joints may be powered as well. One or more powered ankle joints may be includes, as one example.

Each active joint is preferably controlled with a belt-driven series elastic rotary actuator with a harmonic drive transmission (strain wave gearing). In one embodiment, a combination harmonic drive and belt drive system is used to increase the efficiency of the rotary actuator as well as to keep the ultimate size of the exoskeleton leg thin enough to be positioned close to the operator's body.

In this embodiment, loads applied to the joints are sensed using two absolute position encoders supplemented by a motor encoder on the actuator itself. Data signifying motion and/or force of the joint (acceleration, velocity, position, torque, etc.) are preferably all sensed by at least one sensor—though of course a single sensor and integration functions may be used to derive many values. For example, the output of an accurate acceleration sensor may be integrated to derive velocity. In the embodiment, the three encoders as well as an internal spring of an actuator are used to detect bipedal motion of the exoskeleton assembly.

Motor drivers, known as “Turbodrivers” or “MC-30's” are located next to each actuator and are used to control the movement of the joint by reading and analyzing the joint data mentioned above and providing local closed-loop control for position and torque at each actuator. Each Turbodriver contains a drive module and an embedded control system comprising a logic cars that uses in one embodiment a field programmable gate array (FPGA) and a microprocessor, such as a 32-bit RISC (reduced instruction set computer) microprocessor developed by Advanced RISC Machines, Ltd. (also known as an ARM processor) to control the joint at the local level.

In another embodiment, the low-level embedded control system may comprise only a FPGA or only a microprocessor. The drive module is preferably capable of producing over 30 A of continuous current and 60 A peak current. This capability, coupled with the design of the actuator, allows the exoskeleton to produce sufficient joint torque to perform activities such as climbing stairs and other strenuous exercises.

High-level control of the exoskeleton (or joint-by-joint control) may be done wirelessly through a user interface communicating with the onboard CPU located in the backpack. From a separate computer, or via a touch screen worn by the operator, the operator can control movements and responses of the exoskeleton. One way to do this is by programming a desired joint position and/or torque. The desired position is then sent by the CPU to each local joint controller. The Turbodrivers at each joint are then responsible for closing the loop around the current position (or torque) and the desired position. By closing the loop at the embedded actuator level, the exoskeleton is capable of a high level of response from the CPU.

Since the exoskeleton is worn by a human operator, safety is obviously a significant concern. Several layers of safety are preferably built into the system. At the CPU level of control, there is the ability to remove motor power from the device at any time using one or more motion stop buttons. The ability to “freeze” the current position is also provided (which may require maintaining motor torque at some of the joints).

Power to all joints is controlled via a Power Distribution Control Board that ensures there are no faults on the system and all motion stops have been reset before re-enabling any power motor. Redundant motor power relays and carefully programmed startup routines reduce the likelihood of a relay failure (first on, last off conditions as well as soft starts to limit high in-rush currents) and also protect the user in the event of such a failure (if one relay fails and produces a short circuit the other relay in series will remain open).

“Soft” limits—such as joint position and velocity limits—may be set and altered by software. The system will sense a “fault” should any of these limits be exceeded. A fault condition preferably results in motor power being removed from the system in which case the actuators will go into a backdriveable state. In this state the user can easily overcome the back emf of the motors because they are not in a locked-out state. “Hard” limits are set by mechanical stops at the hips and the knees. The mechanical stops prevent the exoskeleton joints moving outside the user's normal range of motion.

Applications of the inventive exoskeleton on earth include resistive exercise for healthy users by increasing the amount of force required for bipedal motion of the legs (walking, running, standing, jumping). The exoskeleton may also assist bipedal motion for persons with a disability such as paraplegia, offloading large amounts of weight from a user, gait modifications or retraining, and rehabilitation. Microgravity applications include countermeasures and dynamometry—allowing a continual assessment of a user's muscle strength while in the microgravity environment.

Although the preceding description contains significant detail, it should not be construed as limiting the scope of the invention but rather as providing illustrations of the preferred embodiments of the invention. Thus, the scope of the present invention should be fixed by the claims rather than the specific examples given.

Having described our invention, we claim:

1. A bipedal exoskeleton configured for use by a human operator, comprising:
a. a backpack harness for attaching said exoskeleton to a torso of said human operator;
b. a chassis connected to said backpack harness;
c. a left exoskeleton leg connected to said chassis, including,
i. a left hip actuator,
ii. a left exoskeleton thigh rotatably connected to said chassis by said left hip actuator,
iii. a left knee actuator connected to a lower portion of said left thigh,
iv. a left exoskeleton calf rotatably connected to said left thigh by said left knee actuator,
v. said left exoskeleton thigh connected to a left thigh of said operator by a left thigh cuff,
vi. said left exoskeleton calf connected to a left calf of said operator by a left shin cuff;
d. a right exoskeleton leg connected to said chassis, including,
i. a right hip actuator,
ii. a right exoskeleton thigh rotatably connected to said chassis by said right hip actuator,
iii. a right knee actuator connected to a loner portion of said right thigh,
iv. a right exoskeleton calf rotatably connected to said right exoskeleton thigh by said right knee actuator,
v. said right exoskeleton thigh connected to a right thigh of said operator by a right thigh cuff,
vi. said right exoskeleton calf connected to a right calf of said operator by a right shin cuff;
e. an electrical power source;
f. a central processing unit;
g. said central processing unit commanding at least a desired position for each of said actuators;
h. each of said actuators including,
a position sensor,
a force sensor, and
a local closed-loop control system apart from said central processing unit, wherein said local control system is able to control said actuator to produce said commanded position for said actuator.

2. A bipedal exoskeleton as recited in claim 1, wherein:
a. said force sensor in at least one of said actuators is able to sense an input force applied by said human operator;
b. said input force is sent to said central processing unit; and
c. said central processing unit actuates at least one of said actuators in response to said input force.

3. A bipedal exoskeleton as recited in claim 2, wherein each actuator included a harmonic drive transmission.

4. A bipedal exoskeleton as recited in claim 3, wherein each actuator includes a belt drive system.

5. A bipedal exoskeleton as recited in claim 1, further comprising:
a. a right ankle assembly extending from a lower portion of said right exoskeleton calf;
b. A right foot plate attached to said right ankle assembly;
c. a left ankle assembly extending from a lower portion of said left exoskeleton calf; and
d. A left foot plate attached to said left ankle assembly.

6. A bipedal exoskeleton as recited in claim 1, wherein:
a. a distance between said right hip actuator and said right knee actuator is adjustable; and
b. a distance between said left hip actuator and said left knee actuator is adjustable.

7. A bipedal exoskeleton as recited in claim 5, wherein:
a. a distance between said right knee actuator and said right foot plate is adjustable; and
b. a distance between said left knee actuator and said left foot plate is adjustable.

8. A bipedal exoskeleton as recited in claim 6, further comprising:
a. a right ankle assembly extending from a lower portion of said right exoskeleton calf;
b. A right foot plate attached to said right ankle assembly;
c. a left ankle assembly extending from a lower portion of said left exoskeleton calf;
d. A left foot plate attached to said left ankle assembly;
e. a distance between said right knee actuator and said right foot plate is adjustable; and
f. a distance between said left knee actuator and said left foot plate is adjustable.

9. A bipedal exoskeleton as recited in claim 1, wherein said backpack harness comprises:
a. a vertical column;
b. a backpack frame;
c. wherein a position of said backpack frame with respect to said vertical column is adjustable.

10. A bipedal exoskeleton as recited in claim 9, wherein said backpack harness further comprises a pair of shoulder straps and a belt.

11. A bipedal exoskeleton configured for use by a human operator, comprising:
a. a backpack harness for attaching said exoskeleton to a torso of said human operator;
c. a chassis, connected to said backpack harness;
d. a housing, connected to said chassis, said housing including, an electrical power source and a central processing unit;
e. a left exoskeleton leg connected to said chassis, including,
i. a left hip actuator,
ii. a left exoskeleton thigh rotatably connected to said chassis by said left hip actuator,
iii. a left knee actuator connected to a lower portion of said left thigh,
iv. a left exoskeleton calf rotatably connected to said left thigh by said left knee actuator,
v. said left exoskeleton thigh connected to a left thigh of said operator by a left thigh cuff,
vi. said left exoskeleton calf connected to a left calf of said operator by a left shin cuff;
f. a right exoskeleton leg connected to said chassis, including,
i. a right hip actuator,
ii. a right exoskeleton thigh rotatably connected to said chassis by said right hip actuator,
iii. a right knee actuator connected to a lower portion of said right thigh,
iv. a right exoskeleton calf rotatably connected to said right exoskeleton thigh by said right knee actuator,
v. said right exoskeleton thigh connected to a right thigh of said operator by a right thigh cuff,
vi. said right exoskeleton calf connected to a right calf of said operator by a right shin cuff;
g. said central processing unit commanding at least a desired position for each of said actuators;
h. each of said actuators including a local closed-loop control system apart from said central processing unit, wherein said local control system is able to control said actuator to produce said commanded position for said actuator.

12. A bipedal exoskeleton as recited in claim 11, wherein:
a. each of said actuators includes a force sensor;
b. said force sensor in at least one of said actuators is able to sense an input force applied by said human operator;
c. said input force is sent to said central processing unit; and
d. said central processing unit actuates at least one of said actuators in response to said input force.

13. A bipedal exoskeleton as recited in claim 12, wherein each actuator included a harmonic drive transmission.

14. A bipedal exoskeleton as recited in claim 13, wherein each actuator includes a belt drive system.

15. A bipedal exoskeleton as recited in claim 11, further comprising:
a. a right ankle assembly extending from a lower portion of said right exoskeleton calf;
b. A right foot plate attached to said right ankle assembly;
c. a left ankle assembly extending from a lower portion of said left exoskeleton calf; and
d. A left foot plate attached to said left ankle assembly.

16. A bipedal exoskeleton as recited in claim 11, wherein:
a. a distance between said right hip actuator and said right knee actuator is adjustable; and
b. a distance between said left hip actuator and said left knee actuator is adjustable.

17. A bipedal exoskeleton as recited in claim 15, wherein:
a. a distance between said right knee actuator and said right foot plate is adjustable; and
b. a distance between said left knee actuator and said left foot plate is adjustable.

18. A bipedal exoskeleton as recited in claim 16, further comprising:
a. a right ankle assembly extending from a lower portion of said right exoskeleton calf;
b. A right foot plate attached to said right ankle assembly;
c. a left ankle assembly extending from a lower portion of said left exoskeleton calf;
d. A left foot plate attached to said left ankle assembly;
e. a distance between said right knee actuator and said right foot plate is adjustable; and
f. a distance between said left knee actuator and said left foot plate is adjustable.

19. A bipedal exoskeleton as recited in claim 11, wherein said backpack harness comprises:
a. a vertical column;
b. a backpack frame;
c. wherein a position of said backpack frame with respect to said vertical column is adjustable.

20. A bipedal exoskeleton as recited in claim 19, wherein said backpack harness further comprises a pair of shoulder straps and a belt.
